(19) United States
(12) Patent Application Publication
(10) Pub. No.: US 2011/0045762 A1
(43) Pub. Date: Feb. 24, 2011

(54) Media Content Preparation And Delivery

(76) Inventors: Soren Brandt, Allerod (DK); Sridhar Solur, London (GB)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/933,427

(22) PCT Filed: Mar. 19, 2008
(86) PCT No.: PCT/GB08/50197

§ 371 Date: Nov. 11, 2010

(51) Int. Cl. H04H 40/00

(52) U.S. Cl. 455/3.06

(57) ABSTRACT

Embodiments of the invention relate to methods of and systems for preparing parallel content for delivery to a plurality of consumers in respective parallel channel communications. The parallel channel content can be playable concurrently with primary channel content, which is broadcast to all said consumers, and wherein the parallel channel content can be different for different consumers.

### FIELD OF THE INVENTION

The present invention relates generally to media content generation and delivery and in particular, but not exclusively, to media content preparation and delivery over a parallel transmission channel, which is associated with a primary transmission channel.

### BACKGROUND OF THE INVENTION

There are many situations in which a parallel channel (sometimes referred to as a “complementary channel”) is used to broadcast information intended to accompany information broadcast over a primary channel. For example, teletext systems may broadcast information relating to a TV programme, or information regarding programs or content being broadcast from a radio station may be broadcast using Radio Digital Service (RDS). Herein, broadcasts over a primary channel are referred to as “primary broadcasts” and broadcasts over a parallel channel are referred to as “parallel broadcasts”.

In particular, Visual Radio (VR) allows a user to listen to a broadcast over a primary channel from a radio station and receive information over a parallel channel relating to the broadcast which is visually displayed on the same device, which may be a mobile communications device such as a mobile telephone or a Personal Digital Assistant (PDA). The visually displayed information may comprise information about a currently broadcast song, such as its release date or trivia regarding a performer of the song, and may comprise links to further information, such as an Internet site from which the song can be purchased and downloaded.

It is desirable that parallel broadcasts are synchronised with respective primary broadcasts, so that the listener is able to view information relevant to the broadcast to which he or she is listening. Therefore, content for parallel broadcasts is typically prepared in advance of the expected transmission of the primary broadcast.

### SUMMARY OF THE INVENTION

According to a first aspect, the present invention provides a method of preparing parallel content for delivery to a plurality of consumers in respective parallel channel communications, said content being playable concurrently with primary channel content, which is broadcast to all said consumers, the method including generating different parallel content for different consumers.

According to a second aspect, the present invention provides a method of delivering parallel content to a plurality of consumers in respective parallel channel communications, said content being playable concurrently with primary channel content, which is broadcast to all said consumers, the method including delivering different parallel content to different consumers.

According to a third aspect, the present invention provides a system for generating parallel content for delivery to a plurality of consumers in respective parallel channel communications, said system comprising a consumer profile database, a content database and processor arranged to generate personalised parallel content on the basis of at least a consumer profile.

According to a fourth aspect, the present invention provides a system for delivering parallel content to a plurality of consumers in respective parallel channel communications, said system comprising a consumer profile database, a content database and processor arranged to generate personalised parallel content on the basis of at least a consumer profile.

According to a fifth aspect, the present invention provides a visual radio system, comprising a primary channel delivery component and a parallel channel delivery component, the primary channel delivery component being arranged to deliver the same primary channel content to a plurality of consumers and the parallel channel delivery component being arranged to deliver different parallel channel content to different consumers, wherein the system is arranged to determine differences in parallel channel content based on at least a consumer profile of the respective consumers.

### BRIEF DESCRIPTION OF THE DRAWINGS

Embodiments of the present invention will now be described, by way of example only, with reference to the following drawings, in which:

FIG. 1 is a schematic diagram showing a system in which embodiments of the present invention may be implemented;

FIG. 2 is a schematic diagram illustrating a primary channel and a number of alternative arrangements of parallel channel, according embodiments of the present invention;

FIG. 3 is a schematic diagram illustrating the main functional components of a VR processor, according to embodiments of the present invention;

FIG. 4 is a flow chart illustrating the steps involved in generating a parallel channel according to embodiments of the present invention; and

FIG. 5 is a schematic diagram illustrating database entries and a resulting parallel channel display, according to an embodiment of the present invention.

### DETAILED DESCRIPTION OF THE INVENTION

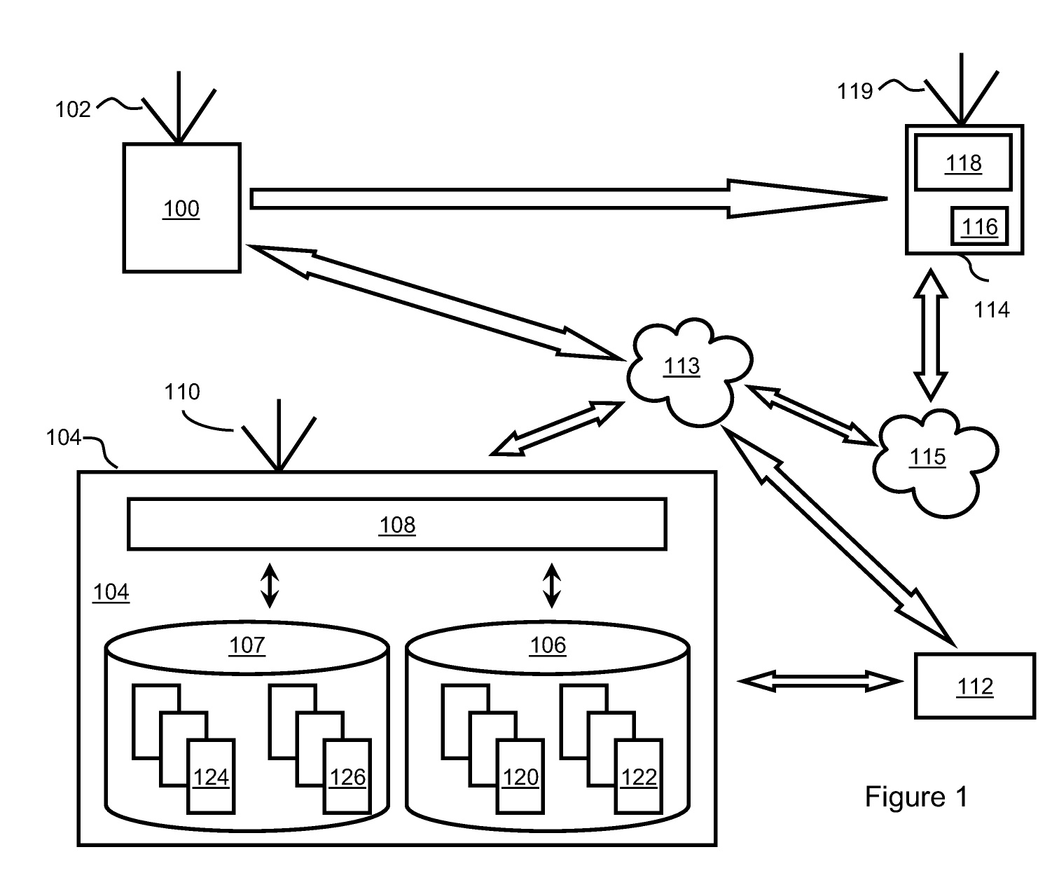

FIG. 1 shows a system in which an embodiment of the present invention can be implemented. The system comprises a primary channel operator 100 which broadcasts audio information via a transmitter 102. In this example, the system is used for VR broadcasting, and the primary channel is a music radio broadcast, but similar systems could be used for broadcasting primary and parallel channels as part of a TV broadcast or an Internet multicast, for example. The radio broadcast of the current example could be made using a digital radio signal according to the Eureka 147 standard (DAB), for example.

The primary broadcast is received by a terminal 114 via an antenna 119. The terminal 114 is adapted to play the audio information received during the primary broadcast via a speaker 116. The terminal 114 is typically a mobile telephone or PDA, though many types of terminal are possible, such as a lap-top or desktop computer, or a digital radio with a display. Although FIG. 1 only shows one terminal 114, it is to be understood that broadcasts are usually received by many terminals, and perhaps many types of terminal. The terminal also comprises a display 118 on which information is displayed, as described below. The display 118 could be an LCD display, for example.

The system of FIG. 1 also includes a parallel channel operator 104. Although the primary channel operator 100 and the parallel channel operator 104 are shown separately in FIG. 1, in some cases, a single operator or organisation may operate both the primary channel and the parallel channel. The parallel channel operator includes an interface 110, a profile database 106, a content database 107 and a VR processor 108, functions and features of which will be described below. The VR processor 108 typically comprises one or more software components running an algorithm, but in some instances it may additionally comprise hardware components such as an Application Specific Integrated Circuit (ASIC).

The parallel channel operator 104 transmits content to be displayed visually at the same time that audio information received from the primary channel operator 100 is played on the terminal 114. Content sent over one or more networks 113, 115 to the terminal 114 includes display timestamps that indicate when the terminal is to show the content. This is usually a system clock time (i.e. an absolute time value), but may also be a delta time, (i.e. a value relative to the time at which it was sent). In effect, a synchronisation between the primary channel and any parallel channel is enforced by the terminal 114 on the basis of the timestamps (or equivalent). Additionally the time stamp may have a special value that means “display immediately”.

The parallel channel operator 104 is connected to the primary channel operator 100; in this example, the link is an Internet connection 113, and the interface is a LAN socket or wireless receiver, but other types of connection, such as an intranet connection, are also possible. This connection enables the parallel channel operator 104 to receive from the primary channel operator 100 information relating to a primary broadcast, such as song titles and artists' names. The parallel channel operator may use this information to compile content information for a corresponding parallel broadcast. However, according to embodiments of the present invention, the parallel channel operator, in addition (or alternatively), is capable of transmitting different parallel streams to different consumers. For example, at least some of the content that is transmitted to one consumer may be different from content that is transmitted concurrently to another consumer. In the present context, ‘concurrent’ is understood to mean at broadly the same time. In principle, the content received by consumers may be generally the same, apart from selected portions, or it may be significantly different or entirely different, as will be described below. In the present context, the term “consumer” can mean either or both ‘a listener or viewer of media content’ and a ‘buyer of goods and services’, for example, that may be advertised on a parallel channel.

The parallel channel operator 104 is able to transmit parallel channel information to the terminal 114, in this example, via a VR server 112, to which the parallel channel operator 114 is connected via an Internet link, and provides content which is in turn accessible by the terminal 114. The terminal 114 typically connects with the VR server via a mobile telephone network 115 with which it communicates using GPRS (General Packet Radio Service), for example, and the Internet 113. The secondary broadcast may use a two channel approach, in which a control channel over a TCP/IP connection and a data channel using HTTP in a request-response mode are used, for example. The terminal 114 typically comprises a VR application to enable information from the parallel broadcast to be displayed on the display 118 and enforce any synchronisation requirements.

As shown in FIG. 1, the profile database 106 comprises a number of consumer profiles 120 and a number of primary channel profiles 122. Each consumer profile 120 contains information which is particular to a person, or, indeed, to a group of people, such as a family or even a group of work colleagues, who may listen to or view the same material at the same time. A consumer profile 120 may include personal status information and shopping preferences. For example, the profile may indicate that the consumer is an affluent male who buys electrical gadgets, an affluent female who enjoys travel or a student who buys modestly-priced fashion clothing. This kind of information can be obtained from various sources in known ways. For example, the information can be: provided by consumers who complete questionnaires to provide the information; obtained by monitoring and capturing a consumer's on-line purchasing behaviour; and obtained by monitoring and capturing a consumer's behaviour while interacting with VR parallel channels. Accordingly, the information may evolve or adapt over time as a consumer's tastes, age, affluence and behaviour change. Some of this kind of information is relatively static, inasmuch as tastes and behaviour tend not to change that quickly, whereas other information such as affluence can change abruptly when a student graduates and starts full time paid employment.

According to the present exemplary embodiment, a consumer profile 120 optionally includes ephemeral information about the consumer, such as a present geographic location. This kind of information can be acquired in known ways by, for example, monitoring respective mobile telephone operation (obviously, as long as it is legal to do so), by using a tracking device, for example, which may be installed in a vehicle or by including a location function in the terminal 114, which transmits present location periodically to a central location database, which can be accessed by the parallel channel operator. Other ways of determining the whereabouts of a consumer will no doubt be apparent.

A primary channel profile 122 may include information that describes and/or classifies a primary channel in terms of the kind of consumer who listens to or views the channel. For example, a classical music radio station may be most popular with a class of consumers, who may, for example, be in the age range 35-50, whereas a popular music radio station may be most popular with consumers in the age range 15-25. In addition, the primary channel classification may vary depending on time of day and/or the kind of program being aired, according to which the consumer demographic may change. This kind of demographic classification is well known and can be applied to both radio and TV stations.

According to the exemplary embodiment, the content database 107 comprises a large number of items of content 124, 126, which can be incorporated into a parallel channel to produce a personalised parallel channel for a particular consumer based on one or more relevant profiles of the profile database 106.

A first kind of content in the content database 107 is content 124 that comprises information, or meta-data, that relates to a primary channel content. This content is referred to herein, for convenience only, as complementary content. For example, in this exemplary embodiment, the primary channel content may be a song and a respective complementary content item may contain various categories of information relating to the song such as title, artist, release year and genre, and album cover image. There may be many thousands or tens of thousands of complementary content items, which relate to all kinds of music. Complementary content of this kind is already known in relation to current VR systems. The complementary content that is reproduced in a parallel channel is dictated by the primary content that is being aired at any particular time.

According to embodiments of the present invention, a second kind of content in the content database 107 is content 126 that can be combined or interspersed with complementary content within a parallel channel in a way that is personal to each respective consumer. This kind of content is referred to herein, for convenience only, as contextual content. It is envisaged that, in some embodiments, contextual content may replace complementary content entirely; though a mix of the two kinds of content is typically desirable. One class of contextual content is advertising content, which advertises products, services or other programmes or channels. Another kind of contextual content is game content, which can include games as such or signals for controlling gaming equipment (for example, signals for controlling a vibration—or ‘rumble’—state of a gaming device, which can be used during playback of other content).

The contextual content that is reproduced in a parallel channel for any particular consumer is influenced by one or more contexts that may include, for example, information in a respective user profile, information in a respective primary channel profile, the date, the season, the time of day, the weather etc. Information relating to weather and the like may be obtained, for example, by regularly accessing known Web and/or Internet services (not shown).

It will be appreciated that the content database 106 and profile database 107 illustrated in FIG. 1 are both shown as a single database for reasons of convenience only: in practice, either (or each) database may in fact comprise multiple databases and/or data sources, which may reside on a single server, in a server farm or even across a distributed storage architecture comprising many servers, for example, connected by the Internet. Such servers may be owned or controlled by a primary channel operator, by a parallel channel operator or by any other party that wishes to make respective content available.

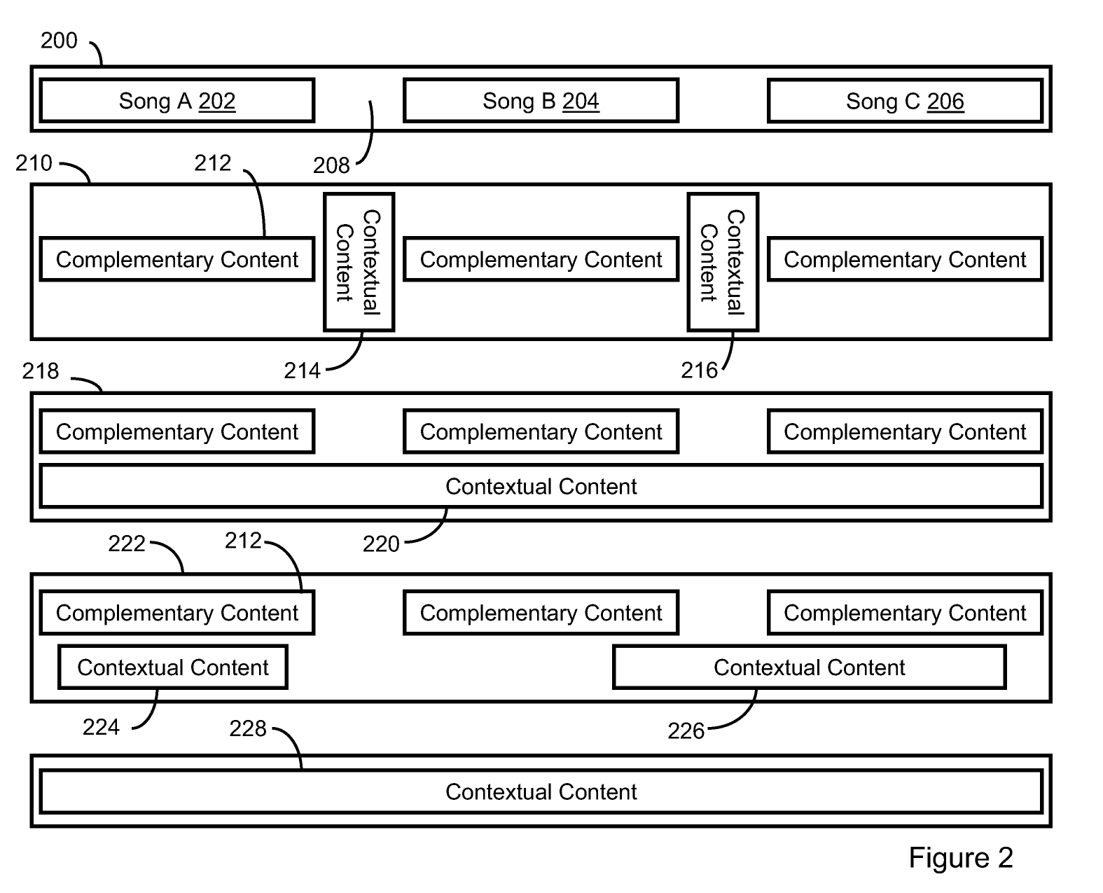

Contextual content may be combined or interspersed with complementary content in a number of ways, as illustrated without limitation in the diagram in FIG. 2. In the diagram, primary content is shown in a primary channel audio stream 200 (for example, played by a music channel) comprising three songs; Song A 202, Song B 204 and Song C 206. Between each song there is a gap 208, which, in practice, may be relatively short or relatively long; though, for convenience, the gaps are of equal length in the depiction. Indeed, some songs may play one after another with no gaps. The gaps may, for example, be filled with news, commentary on the songs by a disk jockey or by adverts. In any event, shown in parallel with the primary audio stream are four exemplary alternative configurations of parallel channel.

In a first exemplary parallel channel 210, complementary content 212 is timed to coincide with playback of each of the songs in the primary channel 200. Contextual content 214 and 216 is shown playing in the gaps between the sections of complementary content.

In a second exemplary parallel channel 218, once again, complementary content 212 is timed to coincide with playback of each of the songs in the primary channel 200. However, in this example, contextual content 220 is shown playing back throughout the time when the songs are being played and even during the gaps between songs.

In a third exemplary parallel channel 222, once again, complementary content 212 is timed to coincide with playback of each of the songs in the primary channel 200. In this example, contextual content is played at different apparent times; for example, in one case 224 in parallel with the complementary content 212 and in another case 226, overlapping with both a gap and complementary content.

In a fourth exemplary parallel channel 228, contextual content is played in parallel with the primary channel 200, without any parallel complementary content being played back.

Many different combinations and arrangements of complementary and/or contextual content can be envisaged, including but not limited to those arrangements exemplified in FIG. 2. In any event, combinations of complementary content and contextual content may be delivered over a single channel. Alternatively, combinations of complementary content and contextual content may be delivered over a plurality of separate parallel channels, which may both (or all) be received by a terminal 114. For example, a terminal 114, may receive complementary content and contextual content in one or more parallel channels and display both kinds of content concurrently on the same display; assuming that the display 118 is sufficiently large to display both kinds of content. Thus, the complementary content could provide information about a record being played whilst the contextual content could be an advert for a record shop, which is near to where the consumer is at the time of playback. In any event, different kinds of parallel content may be received in separate data streams or in one or more parallel or multiplexed data streams.

In known VR systems, a VR processor or equivalent is arranged to generate and broadcast complementary data in a parallel channel, which coincides with a single primary channel and which is received by all recipients who are listening to the primary channel and who are receiving the VR service. In other words, each recipient receives the same complementary channel data. In contrast, according to embodiments of the present invention, the VR processor 108 is adapted to generate a multiplicity of parallel data streams, which are each adapted to a particular consumer or group of consumers. As such, compared with known VR systems, the VR processor 108 is capable of generating significantly more channels of data, which, in the extreme case, may scale linearly with the number of consumers who wish to receive the service. For this reason, the VR processor 108 may comprise a relatively powerful processing capability or, more likely, it may comprise a number of independent processors, for example, running on one or more data servers. Such systems are known in the context of web servers, which are capable of delivering many bespoke streams of data on demand to many consumers in an apparently concurrent manner, and which can be adapted for the present purposes on the basis of the present description.

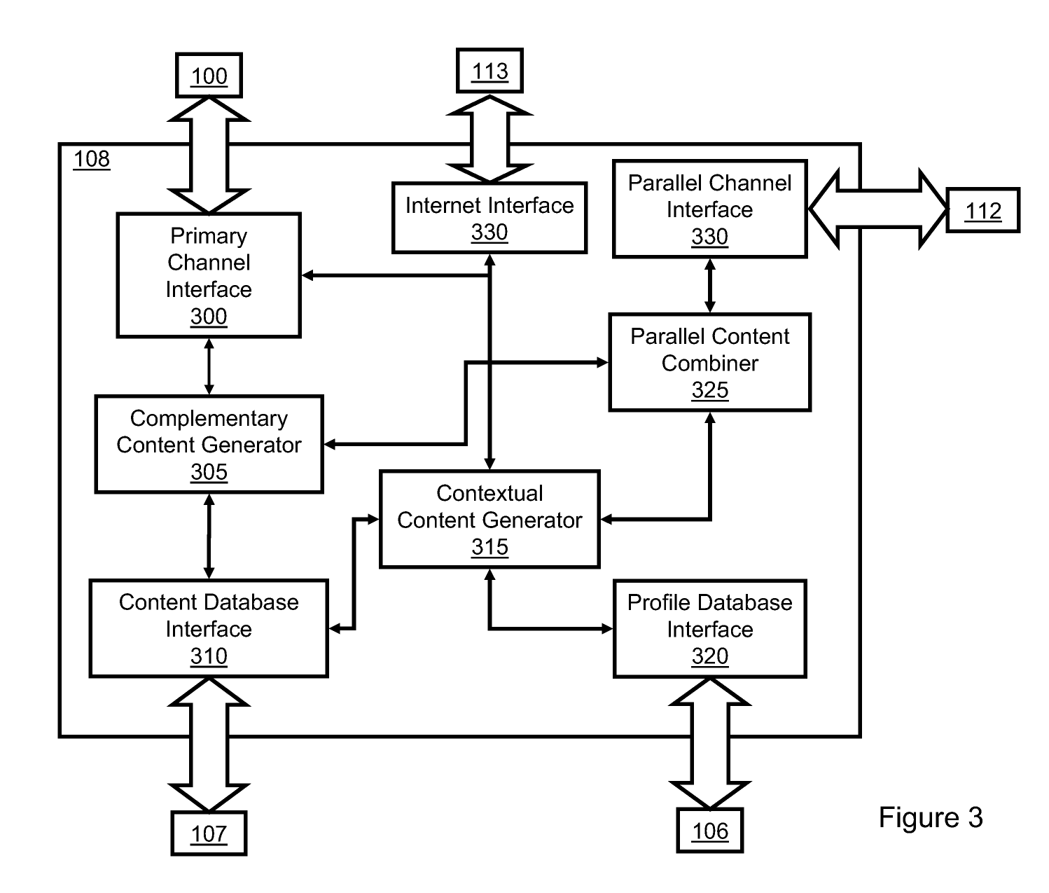

A VR processor 108 according to embodiments of the present invention is illustrated in the functional block diagram of FIG. 3. The VR processor 108 comprises; a complementary content generator 305, which receives from the primary channel operator 100, via a primary channel interface 300, information about primary content to be played; a contextual content generator 315, which also receives, via the primary channel interface 300, from the primary channel operator 100, information about primary content to be played, and also receives contextual content from the content database 107 and consumer profile information 120 and primary channel profile information 122 from the profile database 106; a parallel content combiner 325, which generates a bespoke parallel content channel using complementary content from the complementary content generator 305 and contextual content from the contextual content generator 315, and delivers that content to the VR sever 112, via a parallel channel interface 330, for onwards delivery to a particular consumer. The contextual content generator is also able to obtain information from the Internet 113, for example relating to times, dates, seasons and the weather. According to embodiments of the present invention, this functional model is replicated for each parallel channel that is to be communicated to a consumer.

The complementary content generator 305 operates in a known way to generate complementary content for a given primary channel transmission. The contextual content generator 315 operates to generate contextual content using a multiplicity of data sources; although, in principle, it may only access one data source. A number of examples of contextual content will now be described:
Contextual content may be selected on the basis of a consumer profile. For example, an advert may be selected on the basis of a status of a consumer. An affluent male consumer may be sent an advert for a new kind of mobile telephone, whereas, concurrently, an affluent female consumer may be sent an advert for a holiday company. In each case, the advert is selected from possible adverts stored as contextual content 126 in the content database 107. Ways of selecting advertising content to suit a particular consumer profile are well known in the advertising arts; and respective selection algorithms, as such, will not be considered in any detail herein.
Contextual content may be selected on the basis of a consumer profile including both consumer status and ephemeral information such as consumer location. Then, an advert for a new mobile phone may be accompanied by an advert for a local sales outlet selling the phone. The advert may then be varied depending on where exactly the consumer is.
Contextual content may be selected on the basis of ephemeral user profile only. For example, if it is deduced that a consumer is travelling out of town in their car and that it is approaching a meal time, contextual information may include an advert for a restaurant, which is in the vicinity of the consumer at that point in time. Such an advert would not be useful at other times of day or if the consumer were not close to the particular restaurant. Indeed, restaurant advert content may be associated with selection meta-data indicating that the advert should only be used when approaching meal times and for people who are in the vicinity of the restaurant.
Contextual content may be selected based on date and gender information taken from the consumer profile. For example, if the date is Valentine's day, contextual adverts for that day may include (if the consumer is a man) adverts for where to buy flowers or chocolates in the vicinity of the consumer; or (if the consumer is a woman) where to buy gentleman's clothing, such as a neck tie or casual shirt. Likewise, if a consumer profile contains information about a relative's birthday, similar adverts may be presented as contextual information relating to gift shops in the vicinity.
Contextual content may be selected based on the kind of programme that is being listened to in addition to a consumer's gender taken from the consumer profile. For example, if the programme is playing classical music in the evening, then it may be deduced that the consumer is in an affluent demographic, and it may be known from the consumer profile that the consumer is an adult male. Combined, this information influences the kind of advertising that is appropriate for the consumer, such as luxury holidays or cars.
Contextual content may comprise games, for example trivia games, and be selected based on a consumer profile. For example, different multi-choice trivia questions may be delivered to different consumers based on their age, sex, interests and/or and assumed level of general knowledge. Indeed, trivia questions may be selected based on past performance in answering similar questions, and that performance may be used to adjust a performance level entry in a consumer's profile. In effect, the consumer's performance may be adaptive.
Contextual content may comprise control signals, for example for controlling gaming (or other interactive) equipment that is being used by a consumer. Such signals may, for example, control feedback effects of different kinds of controller, for example a joystick, game-pad, steering wheel, chair or foot-pedal controller, that is being used by a consumer to interact with a game. Each consumer may have different gaming demands that could, in this way, be accommodated by embodiments of the present invention.

In principle, any two or more of the preceding kinds of contextual content may be combined and delivered to consumers.

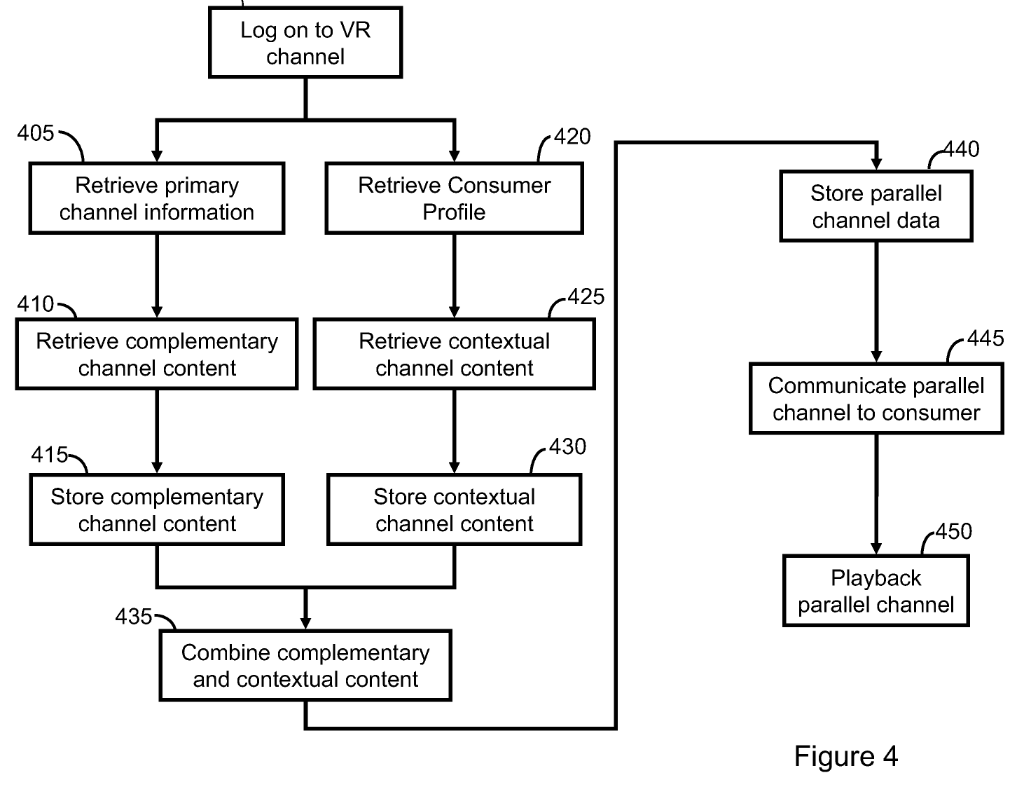

A process for generating a parallel channel in a VR scenario will now be described with reference to the flow diagram in FIG. 4.

In a first step 400, the consumer (who is listening to a primary channel) logs onto a VR channel that is capable of delivering parallel content according to embodiments of the present invention. Next 405, the VR processor 108 receives from the primary channel operator 100 information about the primary channel content that is being (or is about to be) aired. In response to receiving this information, in a step 410, the VR processor 108 accesses the content database 107 and retrieves complementary content 124 that is associated with the primary channel 200. The retrieved complementary content is stored in a step 415. Concurrently, in a next step 420, the VR processor 108, accesses the profile database 106 and retrieves the consumer profile 120. The consumer profile 120 in this example influences all contextual content 220 selections. In a step 425, the VR processor 108 evaluates the consumer profile 120, accesses the content database 107 and retrieves appropriate contextual content 126. For example, the contextual content 126 comprises one or more adverts that would be of interest to the consumer. The contextual content is stored in a step 430. Next, in a step 435, the VR processor 108 combines the complementary content 124 with the contextual content 126 to generate a parallel channel 210, comprising both complementary content components 212 and contextual content components 214. The parallel channel 210 data is stored in step 440. Finally, when required, the parallel channel 210 data is communicated to the consumer in a step 445 and then played by the terminal 114 at the appropriate time.

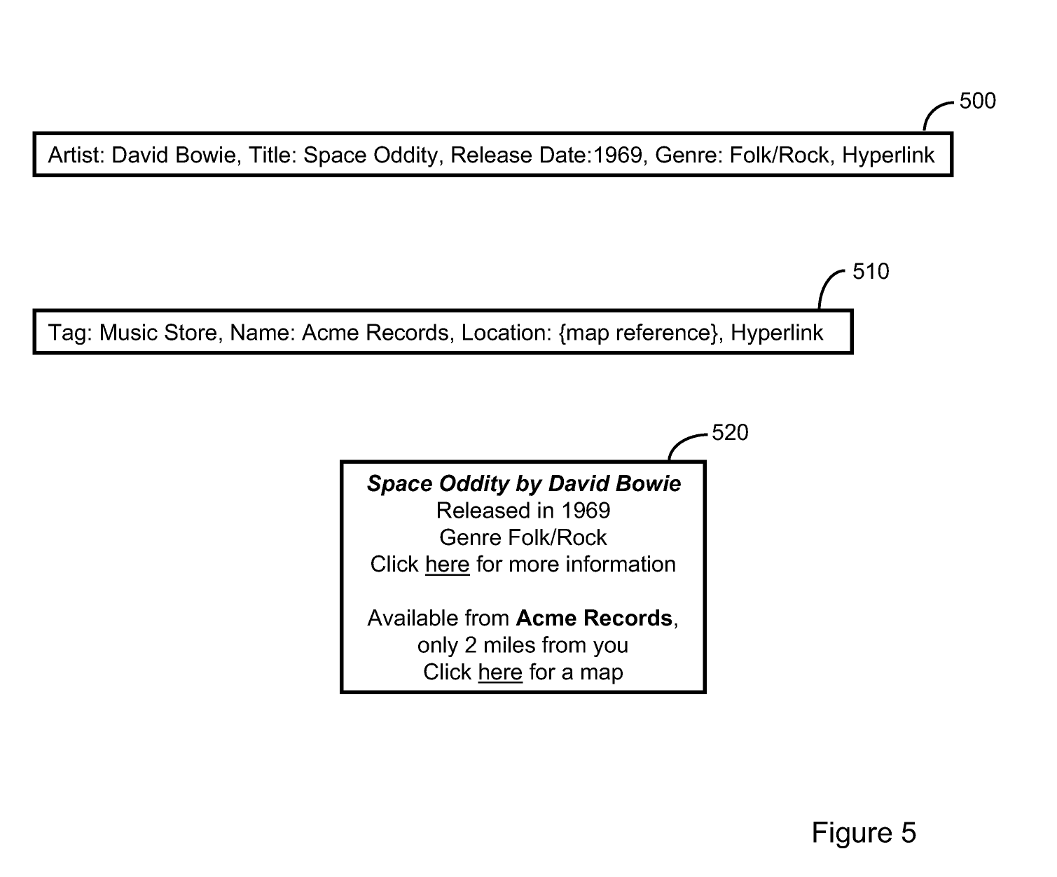

The diagram in FIG. 5 illustrates two content database entries—a complementary content entry 500 and a contextual content entry 510—that have been retrieved from the content database 107 in order to generate a parallel channel component. The complementary content entry 500 is information about a record to be played in the primary channel, and includes the information:

| | |
|---|---|
| Artist | David Bowie |
| Title | Space Oddity |
| Release date | 1969 |
| Genre | Folk/Rock |
| Hyperlink | |

In the example, the title of the record is Space Oddity by the artist David Bowie; the release date is 1969 and the Genre is Folk/Roc. The hyperlink is an HTML link to an on-line database of information, for example a specialist music database, from where more-detailed information about songs and artists can be obtained.

The contextual content entry 510 comprises the details of a music store, including the information:

| | |
|---|---|
| Tag | Music Store |
| Name | Acme Records |
| Location | {map reference} |
| Hyperlink | |

The Tag field describes the kind of store, the Name field is the name of the store, the Location is a GPS co-ordinate (or other location designator) and the hyperlink is a link to a map of the area. In this example, the VR processor 108 is arranged to send to the content database 107 a query including a kind of store and a location of the consumer. The content database 107 receives the query and identifies ‘Acme Records’ as the closest record store to the consumer and returns the associated contextual content entry 510. Of course, other selection criteria for the store may be applied.

Once the VR processor 108 receives both the complementary content entry 500 and the contextual content entry 520, it generates a single HTML screen image 520 by combining both entries. The data defining the image is communicated to the terminal 114 and is then played at the appropriate time. It will be appreciated that the two content entries could in principle be sent separately to the terminal 114, and the terminal could be adapted to produce a single image to be displayed instead.

The example that is illustrated in FIG. 5 includes traditional VR information in the form of the complementary content and, in addition, includes contextual content, according to embodiments of the present invention. The contextual content is selected by considering a feature of the consumer profile, specifically the consumer's location, and the contextual content is retrieved and used to form the parallel channel for that particular consumer.

In general in relation to VR, the present inventors have appreciated that while a primary channel continues to be based on a one-for-all broadcast model and require substantial bandwidth, a contextual channel can be used to feed smaller personalised content, and hence can be personalised and delivered using lower bandwidth connections such as fixed and mobile Internet. More generally, the primary and contextual channels may be presented as one if using a receiving device capable of combining the two in real time. Alternatively, a primary channel may be presented on a television or radio device, whereas a contextual channel could be shown on, for example, a mobile phone device. In relation to advertising, use of contextual content according to embodiments of the present invention can assist advertising campaigns to be far more targeted to individuals or narrow communities or groups. Indeed, embodiments of the present invention make it possible to tailor contextual advertising delivery closely to individual tastes while maintaining the high broadcast quality of primary channel. This has the potential of significantly increasing the broadcaster's advertising revenue.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method of preparing parallel content for delivery to a plurality of consumers in respective parallel channel communications, said content being playable concurrently with primary channel content, which is broadcast to all said consumers, the method including generating different parallel content for different consumers.

2. A method according to claim 1, wherein the parallel content is generated on the basis of a context of each of the said consumers.

3. A method according to claim 2, wherein said context comprises a consumer profile.

4. A method according to claim 3, wherein said consumer profile includes at least one (or any combination) of: personal preferences, historic product purchasing behaviour, gender, financial status, age, geographic location, employment status and past gaming performance.

5. A method according to claim 2, wherein said context comprises at least one of a time, a date and information associated with or classifying the primary channel.

6. A method according to claim 1, wherein the parallel content includes a common component which is common to all said consumers.

7. A method according to claim 6, wherein the common component complements the primary channel content.

8. A method according to claim 6, wherein the common component and the primary channel content are arranged into a playback sequence within which portions of each are arranged to be played at respective times in the playback sequence.

9. A method according to claim 6, wherein the common component and the primary channel content are arranged into a playback sequence within which portions of each are arranged to be played concurrently.

10. A method according to claim 1, wherein the parallel content comprises advertising content.

11. A method according to claim 1, wherein the parallel content comprises at least on of gaming content and gaming control signals.

12. A method according to claim 1, wherein the parallel content comprises visual radio content.

13. A system for delivering parallel content to a plurality of consumers in respective parallel channel communications, said system comprising a consumer profile database, a content database and processor arranged to generate personalised parallel content on the basis of at least a consumer profile.

14. The system of claim 13, wherein the system delivers primary channel content and parallel content in at least one of concurrently and sequentially.

15. The system of claim 14, wherein the parallel content complements the primary channel content.

16. A visual radio system, comprising a primary channel delivery component and a parallel channel delivery component, the primary channel delivery component being arranged to deliver the same primary channel content to a plurality of consumers and the parallel channel delivery component being arranged to deliver different parallel channel content to different consumers, wherein the system is arranged to determine differences in parallel channel content based on at least a consumer profile of the respective consumers.

17. The system of claim 16, wherein the system delivers primary channel content and parallel content in at least one of concurrently and sequentially.

18. The system of claim 17, wherein the parallel content complements the primary channel content.
